(19) United States
(12) Patent Application Publication
(10) Pub. No.: US 2003/0133463 A1
(43) Pub. Date: Jul. 17, 2003

(54) System and method for scheduling transmit messages using credit-based flow control

(75) Inventor: Herbert Lyvirn Lacey III, Garner, NC (US)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(73) Assignee: GlobespanVirata Incorporated, Red Bank, NJ (US)

(21) Appl. No.: 09/683,770

(22) Filed: Feb. 12, 2002

Related U.S. Application Data
(60) Provisional application No. 60/343,200, filed on Dec. 31, 2001.

(51) Int. Cl. H04L 12/28

(52) U.S. Cl. 370/411; 370/229; 370/395.4

(57) ABSTRACT

A system and method for facilitating the scheduling and transmission of transmit protocol messages. Initially, a write credit count is maintained indicating the number of write credits available to a transmit message processor. Upon receipt of a data frame for transmission to a data pump, the transmit message processor determines whether the write credit count is greater than 0. Of so, the frame is dequeued and the message is sent to the data pump for transmission on the wire to a receiving peer end. However, if the write credit count is 0, a waiting_for_write_credit flag is set to true indicating that the transmit processor has a frame waiting for transmission, but lacks sufficient write credits to send the frame to the data pump. Once an additional write credit is received from the data pump, the write credit count is incremented and the waiting_for_write_credit flag is checked to see if any frames are waiting to be send. If so, the transmit message processor is activated, resulting in the transmission of the waiting frame.

### CROSS REFERENCE TO RELATED APPLICATIONS

This application claims the benefit of U.S. provisional patent application Serial No. 60/343,200 filed Dec. 31, 2001, the disclosure of which is incorporated herein by reference.

### BACKGROUND OF THE INVENTION

The present invention relates generally to data processing systems, and in particular, to systems and methods for transmitting and receiving information between such systems across a computer network.

Most modern telecommunications systems utilize some type of modem to package, transmit and receive data a physical medium such as conventional copper telephone lines, fiber optic networks, wireless networks, etc. Generally speaking, a modem is a generic term for any of a variety of modulator/demodulator (hence the term “modem”) devices, which, upon transmission, essentially format digital data signals into signals compatible with the type of network being utilized. In the case of conventional telephone modems, a modem operates to modulate a data signal generated by a computer into an analog format compatible with the PSTN (public switched telephone network). Such modulation may be accomplished in any of a variety of manners, dependent only upon the network protocol as well as the bandwidth capability of the physical medium being used. Examples of modulation techniques may include frequency shift keying (FSK), phase shift keying (PSK), differential phase shift keying (DPSK), and quadrature amplitude modulation (QAM). Essentially, these techniques conduct a bitwise conversion of the digital signal into a corresponding analog signal having a frequency related to the original digital value. In a similar manner to the transmission modulation techniques, modems also operate to receive and demodulate signals back into digital formats readable by a receiving terminal.

As the need for higher speed networks has increased, technology has developed which enables conventional networks to surpass the conventional bandwidth limitations of the PSTN network (i.e., a single 3000 Hz signal transmitted between a user and the phone company's nearest central office (CO)). One such technology generating significant interest is Asynchronous Digital Subscriber Line technology or ADSL. Unlike a conventional modem, an ADSL modem takes advantage of the fact that any normal home, apartment or office has a dedicated copper wire running between it and nearest CO. This dedicated copper wire can carry far more data than the 3,000 hertz signal needed for your phone's voice channel. By equipping both the user and the CO with ADSL modems, the section of copper wire between the two can act as a purely digital high-speed transmission channel having a capacity on the order of 10 Mbps (million bits per second). In essence, an ADSL modem operates to utilize the otherwise unused portion of the available bandwidth in the copper lines, i.e., the bandwidth between 24,000 and 1,100,000 Hz.

Prior to any transmission of actual data between the CO (ATU-C) and the remote computer (ATU-R), the two entities must first undergo a initialization procedure designed to familiarize the two entities with each other, identify the bandwidth capabilities for the current session, and further facilitate the establishment of a valid connection. Pursuant to ADSL standards provided by the International Telecommunication Union—Telecommunication Standardization Sector (ITU-T), these initialization procedures comprise the following: 1) a handshake procedure; 2) a transceiver training session; 3) a channel analysis session; 4) an exchange session; and finally 5) an actual data transmission session referred to as “showtime”.

Relating specifically to the handshake procedure, this procedure is designed to enable peer components to initiate a communications session between each other and generally includes the exchange of several specific messages in the form of activation tones. Examples of such messages include the following: capabilities list and capabilities list request messages; mode select and mode request messages; various acknowledge and negative acknowledge messages. Each of the above messages is generally formulated by a protocol processor responsible for making sure that the requirements for protocol communication are complied with. Further, each message is typically comprised of a plurality of message segments encapsulated into individual data frames for transmission to the peer end.

Once a message has been framed by the protocol processor in accordance with a standardized format, the various frames are placed in data buffers and are then sent to the physical layer for actual transmission on the wire to the peer end. In most circumstances, the physical layer comprises a data pump for modulating the frame and sending it out on the wire. Because most conventional data pumps are relatively simple devices, they may only be capable of handling a preset number of data buffers (e.g., 2), simultaneously. In order to notify the protocol processor how may buffers it could handle, a system of write credits was established, wherein the data pump would continually issue write credits to the protocol processor, each write credit indicating that the data pump can accept a new data buffer for transmission on the line to the peer end. Unfortunately, many messages comprise more than two frames. If sufficient write credits are not available to send the entire message to the data pump, the protocol processor is forced to wait for write credits to become available from the data pump, thereby creating a bottleneck in the device, which may result in a unacceptable delay or other form of timeout.

Therefore, there is a need in the art of write credit based data pumps, for an improved system and method for scheduling and sending transmit protocol messages through the data pump the peer end without requiring such delays on the part of the protocol processor.

### SUMMARY OF THE INVENTION

The present invention overcomes the problems noted above, and provides additional advantages, by providing a system and method for facilitating the scheduling and transmission of transmit protocol messages. Initially, a write credit count is maintained indicating the number of write credits available to a transmit message processor. Upon receipt of a data frame for transmission to a data pump, the transmit message processor determines whether the write credit count is greater than 0. If so, the frame is dequeued and the message is sent to the data pump for transmission on the wire to a receiving peer end. However, if the write credit count is 0, a waiting_for_write_credit flag is set to true indicating that the transmit processor has a frame waiting for transmission, but lacks sufficient write credits to send the frame to the data pump. Once an additional write credit is received from the data pump, the write credit count is incremented and the waiting_for_write_credit flag is checked to see if any frames are waiting to be send. If so, the transmit message processor is activated, resulting in the transmission of the waiting frame.

### BRIEF DESCRIPTION OF THE DRAWINGS

FIG. 1 is a simplified block diagram of a portion of a network communications transceiver system implementing the methodology of the present invention.

FIG. 2 is a flow diagram illustrating one embodiment of a method for scheduling and transmitting transmit protocol messages in accordance with the present invention.

FIG. 3 is a flow diagram illustrating one embodiment of a method for maintaining a write credit interface in accordance with the present invention.

### DETAILED DESCRIPTION OF THE INVENTION

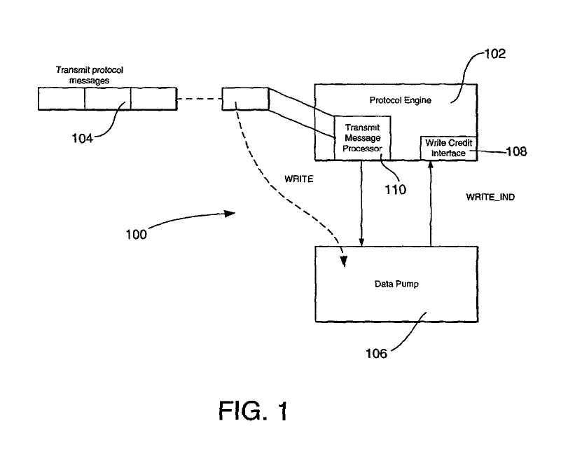

Referring now to the Figures and, in particular, to FIG. 1, there is shown a simplified block diagram of a portion of a network communications transceiver system 100 implementing the methodology of the present invention. In particular, a protocol engine 102 is provided for formatting transmit protocol messages 104 for transmission to a peer end, typically in response to either user-initiated activities or in response to received peer end messages.

As described above, transmit protocol messages 104 are comprised of a plurality of data frames and stored in data buffers for transmission by the data pump 106. In accordance with the present invention, the protocol processor 102 also maintains a write credit interface 108, wherein write credits received from the data pump are received and maintained. Further a transmit message processor 110 is maintained in conjunction with the protocol processor 102 for handling the scheduling and transmission of protocol messages in response to write credits received from the data pump.

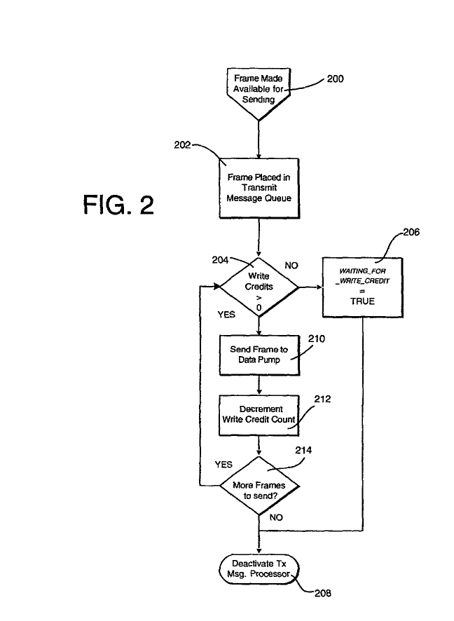

Referring now to FIG. 2, there is shown a flow diagram illustrating one embodiment of a method for scheduling and transmitting transmit protocol messages in accordance with the present invention. In step 200, a transmit protocol frame is made available to the transmit message processor for sending to the data pump. In step 202, the frame is placed into a transmit message queue. Next, in step 204, the transmit message processor examines a write credit count and determines whether a write credit is available, thus indicating that the frame may be sent to the data pump. If no write credit is available (i.e., write credits=0), a waiting_for_write_credit flag is set equal to true in step 206, indicating that the transmit message processor is waiting for a write credit. The transmit message processor is then deactivated in step 208 until a write credit is made available.

If a write credit was determined to be available in step 204, the transmit message is dequeued and the frame is sent to the data pump in step 210. In step 212, the write credit count is decremented, indicating that the credit has been used to send a frame to the data pump. In step 214 it is determined whether the message of which the sent frame was a part of includes additional frames. If so, the process returns to step 204 where it is again determined whether a write credit exists to send the next frame to the data pump. Otherwise, the processor deactivates in step 208 awaiting additional message frames from the protocol processor.

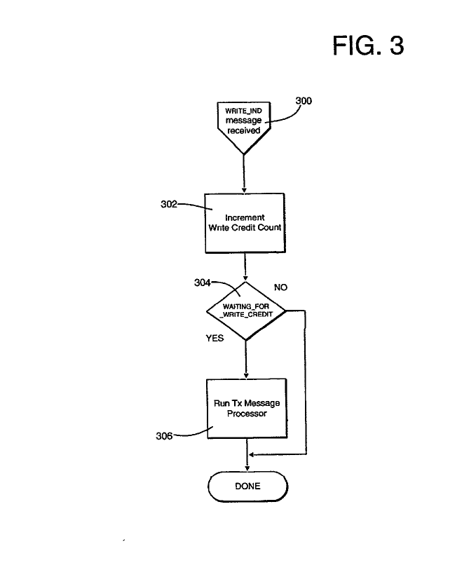

Referring now to FIG. 3, there is shown a flow diagram illustrating one embodiment of a method for maintaining a write credit interface in accordance with the present invention. In step 300, a write credit is received into the transmit message processor. In step 302, the write credit count is incremented to indicate the additional write credit received. In step 304, it is determined whether the transmit message processor is waiting for a write credit to send a queued frame. That is, it is determined whether waiting_for_write_credit flag is set equal to true. If so, the transmit message processor is activated in step 306. Since a write credit has now been made available, the waiting frame will necessarily follow the path of steps 200, 204, 210, 212, and 214, set forth above. Otherwise, the process terminates with the write credit count being incremented.

The invention provides a robust method of scheduling transmit protocol messages in a system using credit-based flow control between a protocol engine and a physical layer. By providing a transmit message frame queue and a independent transmit message processor, the protocol processor is not forced to wait on write credits from the data pump prior to proceeding with other operations. This significantly increases the likelihood that the protocol processor will meet its required real-time deadlines, thereby increasing system performance and stability. It should be understood that although the above description is referenced specifically to handshake transmit messages between a protocol processor and a data pump, the present invention may be implemented in any system utilizing a credit based flow control between modules or layers of a communications stack.

The following is one exemplary embodiment of computer software code for implementing the above-described invention. It should be understood that this illustrative of the methodology described above and, accordingly, the present invention is not limited to this embodiment.

/* transmit message processor interface */

/* if there is another frame to send */

TxFrameToSend = hs_TxFrameToSend(pInstData);
if (TRUE == TxFrameToSend)
{

/* if data pump has issued write credit for another data frame */
if (pGhsInst−>WriteCredits > 0)
{

/* dequeue and send frame */
pMsg = (SCTMSG*) SYSQUE_Dequeue(&(pGhsInst−>HsTxMsg.MsgQ));
ASSERT(pMsg != NULL);
/* update the available buffers - but not less than zero */
if (pGhsInst−>HsTxMsg.HsTotalBuffers > 0)
{

pGhsInst−>HsTxMsg.HsTotalBuffers−−;

}
/* else done sending the message */
else
{

hs_DeactivateTxMsgProcessor(pInstData);

}
/* if frame was successfully dequeued */
if (pMsg != NULL)
{

#ifdef HS_SHOW_TX_DATA

hs_DebugShowTxData(pMsg, pInstData);

#endif
SctResult =

hs_SendMsg(pMsg, pGhsInst−>belowInstId, pGhsInst−>myInstId,

Write, pInstData);

ASSERT(SctResult);
/* if system msg send succeeded */
if (FALSE != SctResult)
{

/* update the available write credits − but not less than zero */
if (pGhsInst−>WriteCredits > 0)
{

pGhsInst−>WriteCredits−−;

}

}
/* else system msg send failed */

else

{

HS_BREAKPOINT_INTO(HS_STATUS_08);

}

} /* if (pMsg != NULL), frame was successfully dequeued */
/* else tx buffer dequeueing failure − fatal error */
else

{

/*
* stop the tx message processor and notify system error handling
* of fatal error
*/
hs_DeactivateTxMsgProcessor(pInstData);
HS_INDICATE_SYSTEM_ERROR(FATAL_ERROR);

} /* else buffer dequeueing failure − fatal error */

} /* if write credit */
/*
* else the data pump has not yet issued sufficient write credit
* (since pGhsInst−>WriteCredits == 0) to send the frame,
* so wait for write credit before sending the frame.
*/
else
{

/* there must be some tx buffers on queue */
ASSERT(pGhsInst−>HsTxMsg.HsTotalBuffers > 0);
/* if there are some buffers to send, guarantee msg in progress status */
if (pGhsInst−>HsTxMsg.HsTotalBuffers > 0)
{

pGhsInst−>HsTxMsg.HsMsgInProgress = TRUE;
pGhsInst−>HsWaitingForWriteCredit = TRUE;

}

} /* else there is a frame to send, but insufficient write credit */

} /* if there is another frame to send */

/* write credit interface */

void hs_ProcessRcvMsg_WriteInd( void *pInstData, SCTMSG *pMsg )
{

GHS_CB *pGhsInst;
pGhsInst = (GHS_CB *)pInstData;
pGhsInst−>WriteCredits++;
/*
* WRITE_IND messages from the data pump are translated into Event
* E_PUMP_CFM_DATA by this routine.
*/
/*
* if HANDSHAKING
*/
if (GHS_HANDSHAKING == pGhsInst−>state)
{

/* if there is another frame to send */
if ((FALSE != pGhsInst−>HsWaitingForWriteCredit) && \

(FALSE != hs_TxFrameToSend(pInstData) ))

{

/* were waiting for data pump Write Credits = now reset this status */
pGhsInst−>HsWaitingForWriteCredit = FALSE;
/* process any outgoing tx frame */
hs_RunTxMsgProcessor(pInstData);

}

}
else
{

/* else ignore the erroneous WRITE_IND */
HS_BREAKPOINT_INT2(HS_STATUS_07);

}
/* free up the message buffer −− no longer needed */
if(pMsg != NULL)
{

FREE(SCTBUF_MSG, pMsg);

}
hs_ProcessEvent( pInstData, E_PUMP_CFM_DATA);

} /* routine */

While the foregoing description includes many details and specificities, it is to be understood that these have been included for purposes of explanation only, and are not to be interpreted as limitations of the present invention. Many modifications to the embodiments described above can be made without departing from the spirit and scope of the invention.

What is claimed is:

1. A method for scheduling and transmitting transmit protocol messages, comprising the steps of:
receiving a data frame for transmission to a data pump;
inserting the data frame into a transmit message queue;
determining whether a write credit count is greater than 0;
performing the following steps if it is determined that the write credit count is greater than 0:
dequeuing the data frame;
sending the data frame to the data pump;
decrementing the write credit count; and
setting a waiting_for_write_credit flag is to true, indicating that the transmit processor has a frame waiting for transmission, but lacks sufficient write credits to send the frame to the data pump, if it is determined that the write credit count is not greater than 0.

2. The method of claim 1, further comprising the steps of:
receiving an additional write credit from the data pump;
incrementing the write credit count to reflect the received additional write credit;
determining whether the waiting_for_write_credit flag is set to true; and
performing the following steps if it is determined that the waiting_for_write_credit flag is set to true:
dequeuing the data frame;
sending the data frame to the data pump; and
decrementing the write credit count.

3. The method of claim 1, further comprising the step of transmitting the data frame on to a receiving peer end following the step of sending the data frame to the data pump.

4. The method of claim 1, wherein, following the step of decrementing the write credit count, the following steps are performed:
determining whether the data frame was a part of a message including at least one additional frame;
performing the following steps if it is determined that the data frame was a part of a message including at least one additional data frame:
receiving an additional data frame;
inserting the additional data frame into the transmit message queue;
determining whether a write credit count is greater than 0;
performing the following steps if it is determined that the write credit count is greater than 0:
dequeuing the additional data frame;
sending the additional data frame to the data pump;
decrementing the write credit count; and
setting a waiting_for_write_credit flag is to true, indicating that the transmit processor has a frame waiting for transmission, but lacks sufficient write credits to send the frame to the data pump, if it is determined that the write credit count is not greater than 0.

5. A system for scheduling and transmitting transmit protocol messages, comprising:
means for receiving a data frame for transmission to a data pump;
means for inserting the data frame into a transmit message queue;
means for determining whether a write credit count is greater than 0;
means for dequeuing the data frame if it is determined that the write credit count is greater than 0;
means for sending the data frame to the data pump following the dequeuing of the data frame;
means for decrementing the write credit count following sending of the data frame to the data pump; and
means for setting a waiting_for_write_credit flag is to true, indicating that the transmit processor has a frame waiting for transmission, but lacks sufficient write credits to send the frame to the data pump, if it is determined that the write credit count is not greater than 0.

6. The system of claim 5, further comprising:
means for receiving an additional write credit from the data pump;
means for incrementing the write credit count to reflect the received additional write credit;
means for determining whether the waiting_for_write_credit flag is set to true; and
means for dequeuing the data frame if it is determined that the waiting_for_write_credit flag is set to true;
means for sending the data frame to the data pump following the dequeuing of the data frame;
means for decrementing the write credit count following sending of the data frame to the data pump.

7. The system of claim 5, further comprising means for transmitting the data frame on to a receiving peer end following the sending of the data frame to the data pump.

8. The system of claim 5, further comprising:
means for determining whether the data frame was a part of a message including at least one additional frame following the decrementing of the write credit count;
means for determining whether a write credit count is greater than 0 if it is determined that the data frame was a part of a message including at least one additional data frame;
means for receiving an additional data frame;
means for inserting the additional data frame into the transmit message queue;
means for dequeuing the additional data frame if it is determined that a write credit count is greater than 0;
means for sending the additional data frame to the data pump following dequeuing of the data frame;
means for decrementing the write credit count following the sending of the additional data frame to the data pump; and
means for setting the waiting_for_write_credit flag is to true if it is determined that the write credit count is not greater than 0.

9. A computer readable medium incorporating one or more instructions for scheduling and transmitting transmit protocol messages, the instructions comprising:
one or more instructions for receiving a data frame for transmission to a data pump;
one or more instructions for inserting the data frame into a transmit message queue;
one or more instructions for determining whether a write credit count is greater than 0;
one or more instructions for executing the following instructions if it is determined that the write credit count is greater than 0:
one or more instructions for dequeuing the data frame;
one or more instructions for sending the data frame to the data pump;
one or more instructions for decrementing the write credit count; and
one or more instructions for setting a waiting_for_write_credit flag is to true, indicating that the transmit processor has a frame waiting for transmission, but lacks sufficient write credits to send the frame to the data pump, if it is determined that the write credit count is not greater than 0.

10. The computer readable medium of claim 9, the instructions further comprising:
one or more instructions for receiving an additional write credit from the data pump;
one or more instructions for incrementing the write credit count to reflect the received additional write credit;
one or more instructions for determining whether the waiting_for_write_credit flag is set to true; and
one or more instructions for executing the following instructions if it is determined that the waiting_for_write_credit flag is set to true:
one or more instructions for dequeuing the data frame;
one or more instructions for sending the data frame to the data pump; and
one or more instructions for decrementing the write credit count.

11. The computer readable medium of claim 9, further comprising one or more instructions for transmitting the data frame on to a receiving peer end following the one or more instructions for sending the data frame to the data pump.

12. The computer readable medium of claim 9, wherein, following the one or more instructions for decrementing the write credit count, the following instructions are executed:
one or more instructions for determining whether the data frame was a part of a message including at least one additional frame;
one or more instructions for executing the following instructions if it is determined that the data frame was a part of a message including at least one additional data frame:
one or more instructions for receiving an additional data frame;
one or more instructions for inserting the additional data frame into the transmit message queue;
one or more instructions for determining whether a write credit count is greater than 0;
one or more instructions for executing the following instructions if it is determined that the write credit count is greater than 0:
one or more instructions for dequeuing the additional data frame;
one or more instructions for sending the data frame to the data pump;
one or more instructions for decrementing the write credit count; and
one or more instructions for setting a waiting_for_write_credit flag is to true, indicating that the transmit processor has a frame waiting for transmission, but lacks sufficient write credits to send the frame to the data pump, if it is determined that the write credit count is not greater than 0.
